(19) United States
(12) Patent Application Publication
(10) Pub. No.: US 2009/0324876 A1
(43) Pub. Date: Dec. 31, 2009

(54) MULTI-LAYER BAMBOO PLYWOOD AND MANUFACTURING METHOD THEREOF

(76) Inventors: Yiquan Yang, Fujian (CN); Yan Yang, Fujian (CN)

Correspondence Address: Nixon Peabody LLP, 200 Page Mill Road, Suite 200, Palo Alto, CA, 94306, US

(21) Appl. No.: 12/300,125

(22) PCT Filed: Oct. 18, 2006
(86) PCT No.: PCT/CN2006/002761

§ 371 Date: Apr. 15, 2009

(30) Foreign Application Priority Data
May 10, 2006 (CN) 200610080097.7

(51) Int. Cl. B32B 3/06; B32B 38/10

(52) U.S. Cl. 428/99; 156/267; 428/22

(57) ABSTRACT

The multi-layer bamboo plywood with high work strength isn't liable to warp, characterized in that said plywood is composed of bamboo strips or strip-shaped bamboo compositing materials that are superposed and glued one with respect to another, the side of said plywood is provided with a through hole running through the plywood perpendicular to said side, tensioned wires with high tenacity and elasticity are provided within said through hole and a fastening assembly is disposed at the end of said wires. The advantages of this invention consist in high strength, excellent abrasion resistance and being not liable to warp, which contribute to flat connection in series and long service life. Said bamboo plywood is a perfect substitute for lumber, and the wide use thereof will remarkably save lumber and thereby protect the forest resources.

### FIELD

This invention relates to a multi-layer bamboo plywood and manufacturing method thereof.

### BACKGROUND

An existing type of bamboo plywood is fabricated through hot gluing of bamboo sheets. After hot-pressing forming, the bonding strength of plywood is low. The plywood is fragile, and the operating factor of bamboo wood is low.

### SUMMARY OF THE INVENTION

The purpose of this invention is to provide a new type of Multi-layer bamboo plywood with high work strength isn't liable to warp.

The structural characteristics of this invention are that: the Multi-layer bamboo plywood is composed of bamboo strips or strip-shaped bamboo composite materials that are superposed and glued one with respect to another. The side of said plywood is provided with a through-hole running through the plywood perpendicular to said side, tensioned wires with high tenacity and elasticity are provided within said through hole and a fastening assembly is disposed at the end of said wires.

The advantages of this invention consist in high strength, excellent abrasion resistance and being not liable to warp, which contribute to flat connection in series and long service life. Said bamboo plywood is a perfect substitute for lumber, and the wide use thereof will remarkably save lumber and thereby protect the forest resources.

### BRIEF DESCRIPTION OF THE DRAWING

FIG. 1 is the schematic view of Embodiment 1 of this invention;

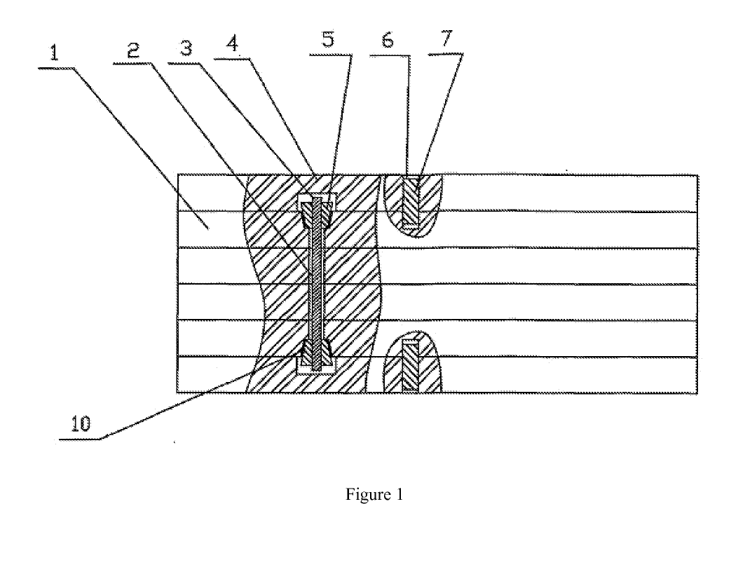

FIG. 2 is the schematic view of Embodiment 2 of this invention;

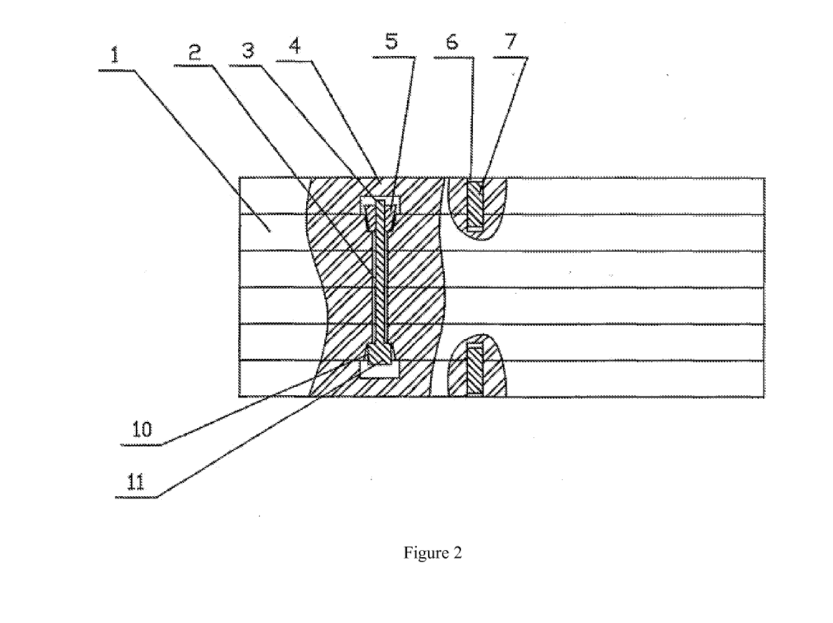

FIG. 3 is the schematic view of fastening assembly of this invention;

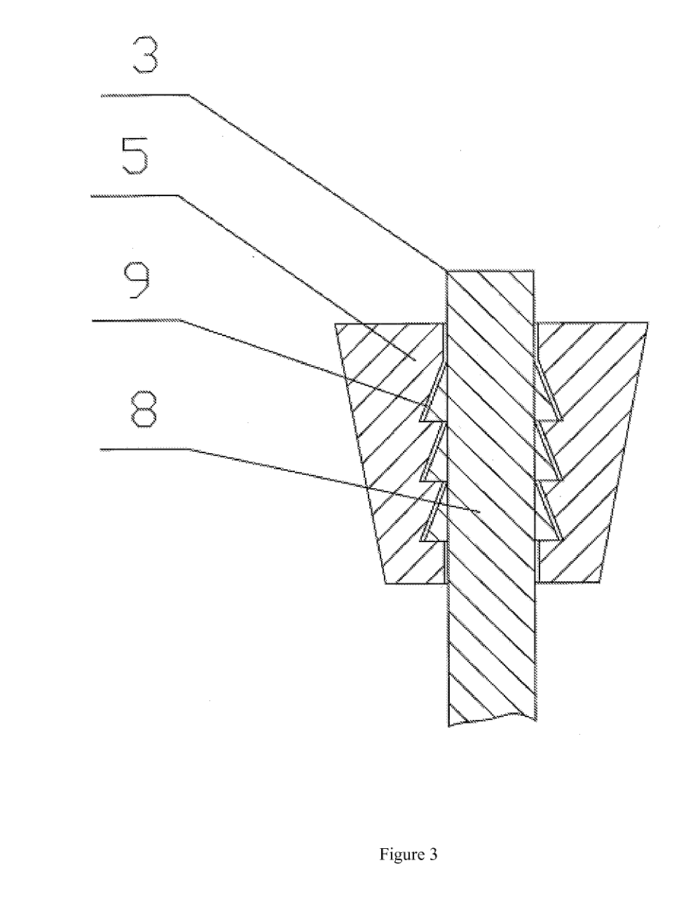

### DETAILED DESCRIPTION

Embodiment 1 of this invention: Multi-layer bamboo plywood is composed of bamboo strips or strip-shaped bamboo composite materials 1 that are superposed and glued one with respect to another. Said plywood has a through-hole 2 set on its side edge that is perpendicular to the plywood. A wire 3 with high tenacity and elasticity is set inside the through-hole and tautened. The wire 3 has fastening assembly set at both ends. Said wire 3 with high tenacity and elasticity is metal or non-metal.

The above-mentioned fastening assembly is composed of the protruding end 8 of the metal wire and anchoring assembly 5 set on both sides of the protruding end 8. Said anchoring assembly 5 is a conical one made of metal, plastic or other similar material. It is formed by snapping two halves together or comes as a whole with serrated grooves 9 on the inner wall. The conical anchoring assembly is located in the conical hole 10 on the side edge of the plywood.

The above-mentioned plywood has side edgings 4 attached to both side edges to cover the ends of fastening assembly. A connection pinhole 6 is set in the bamboo strip next to side edging 4. Connection pin 7 is inserted into connection pinhole 6.

The manufacturing method of the above-mentioned Multi-layer bamboo plywood is as follows: 1) process bamboo strips according to the shape and size need for bamboo plywood; 2) array bamboo strips needed for each group and drill holes in bamboo strips where the metal wire goes through; 3) put the metal wire through the holes, and use a tensile machine to put the metal wire under force for elastic deformation or use a heater to heat the metal wire for thermal expansion; 4) install anchoring assemblies to both ends of the metal wire while it is still in elastic deformation or thermal expansion; 5) release the metal wire from the tensile machine or heater, and allow it to contract. The frictional force between the protruding end of the metal wire and the serrated grooves of the anchoring assembly will keep the metal wire from contracting and thus fasten the bamboo strips; 6) cut excess metal wire off both ends; 7) attach side edgings to both side edges of the plywood.

Embodiment 2 of this invention: Multi-layer bamboo plywood is composed of bamboo strips or strip-shaped bamboo composite materials 1 that are superposed and glued one with respect to another. Said plywood has a through-hole 2 set on its side edge that is perpendicular to the plywood. A wire 3 with high tenacity and elasticity is set inside the through-hole and tautened. The wire 3 has fastening assembly set at both ends. Said wire 3 with high tenacity and elasticity is metal or non-metal. One end of the metal wire is fixed to a rivet 11.

The above-mentioned fastening assembly is composed of the protruding end 8 of the metal wire and anchoring assembly 5 set on both sides of the protruding end 8. Said anchoring assembly 5 is a conical one made of metal, plastic or other similar material. It is formed by snapping two halves together or comes as a whole with serrated grooves 9 on the inner wall. The conical anchoring assembly is located in the conical hole 10 on the side edge of the plywood.

The above-mentioned plywood has side edgings 4 attached to both side edges to cover the ends of fastening assembly. A connection pinhole 6 is set in the bamboo strip next to side edging 4. Connection pin 7 is inserted into connection pinhole 6.

The manufacturing method of the above-mentioned Multi-layer bamboo plywood is as follows: 1) process bamboo strips according to the shape and size need for bamboo plywood; 2) array bamboo strips needed for each group and drill holes in bamboo strips where the metal wire goes through; 3) put the metal wire fixed to a rivet through the holes, and use a tensile machine to pull the other end of the metal wire for elastic deformation or use a heater to heat the metal wire for thermal expansion; 4) install anchoring assemblies to both ends of the metal wire while it is still in elastic deformation or thermal expansion; 5) release the metal wire from the tensile machine or heater, and allow it to contract. The frictional force between the metal wire and the serrated grooves of the anchoring assembly will keep the metal wire from contracting and thus fasten the bamboo strips; 6) cut excess metal wire off both ends; 7) attach side edgings to both side edges of the plywood.

1. A Multi-layer bamboo plywood, characterized in that: the Multi-layer bamboo plywood is composed of bamboo strips or strip-shaped bamboo composite materials that are superposed and glued one with respect to another, the side of said plywood is provided with a through-hole running through the plywood perpendicular to said side, tensioned wires with high tenacity and elasticity are provided within said through hole and a fastening assembly is disposed at the end of said wires.

2. Multi-layer bamboo plywood according to claim 1, characterized in that: said tensioned wires with high tenacity and elasticity are metal or non-metal.

3. Multi-layer bamboo plywood according to claim 1 or claim 2, characterized in that: said fastening assembly is composed of the protruding end of the metal wire and anchoring assembly, which has serrated grooves on the inner wall, set on both sides of the protruding end.

4. Multi-layer bamboo plywood according to claim 3, characterized in that: said anchoring assembly is a conical one made of metal, plastic or other similar material, it is formed by snapping two halves together or comes as a whole with serrated grooves on the inner wall, the conical anchoring assembly is located in the conical hole on the side edge of the plywood.

5. Multi-layer bamboo plywood according to claim 4, characterized in that: one end of the metal wire is fixed to a rivet.

6. Multi-layer bamboo plywood according to claim 5, characterized in that: said plywood has side edgings attached to both side edges to cover the ends of fastening assembly; a connection pinhole is set in the bamboo strip next to the side edging; the connection pin is inserted into connection pinhole.

7. Multi-layer bamboo plywood according to claim 6, its manufacturing method being: 1) process bamboo strips according to the shape and size need for bamboo plywood; 2) array bamboo strips needed for each group and drill holes in bamboo strips where the metal wire goes through; 3) put the metal wire through the holes, and use a tensile machine to put the metal wire under force for elastic deformation or use a heater to heat the metal wire for thermal expansion; 4) install anchoring assemblies to both ends of the metal wire while it is still in elastic deformation or thermal expansion; 5) release the metal wire from the tensile machine or heater, and allow it to contract. The frictional force between the protruding end of the metal wire and the serrated grooves of the anchoring assembly will keep the metal wire from contracting and thus fasten the bamboo strips; 6) cut excess metal wire off both ends; 7) attach side edgings to both side edges of the plywood.

8. Multi-layer bamboo plywood according to claim 6, its manufacturing method being: 1) process bamboo strips according to the shape and size need for bamboo plywood; 2) array bamboo strips needed for each group and drill holes in bamboo strips where the metal wire goes through; 3) put the metal wire fixed to a rivet through the holes, and use a tensile machine to pull the other end of the metal wire for elastic deformation or use a heater to heat the metal wire for thermal expansion; 4) install anchoring assemblies to both ends of the metal wire while it is still in elastic deformation or thermal expansion; 5) release the metal wire from the tensile machine or heater, and allow it to contract. The frictional force between the metal wire and the serrated grooves of the anchoring assembly will keep the metal wire from contracting and thus fasten the bamboo strips; 6) cut excess metal wire off both ends; 7) attach side edgings to both side edges of the plywood.
